(19) United States
(12) Patent Application Publication
(10) Pub. No.: US 2006/0138696 A1
(43) Pub. Date: Jun. 29, 2006

(54) Method and device for the secondary treatment and the cooling of preforms

(76) Inventor: Robert Weinmann, Weesen (CH)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/533,774

(22) PCT Filed: Feb. 21, 2003
(86) PCT No.: PCT/CH03/00132

§ 371 Date: Mar. 3, 2006

(30) Foreign Application Priority Data
Nov. 5, 2002 (CH) 1850/02
Jan. 17, 2003 (CH) 0063/03
Feb. 19, 2003 (CH) 0247/03

(51) Int. Cl. B29C 45/38; B29C 71/00

(52) U.S. Cl. 264/237; 425/552; 264/328.14; 264/334

(57) ABSTRACT

The invention relates to a method and a device for the secondary treatment and the cooling of preforms (10) once they have been removed from the open mould halves (18, 9) of an injection moulding machine. The preforms are removed from the open moulds (18, 9) while still hot, by means of water-cooled cooling sleeves (21) of a removal device (11), and are subjected to intensive cooling during the duration of an injection moulding cycle. Both the entire inner side and the entire outer side of the blow-moulded part (10) are subjected to intensive cooling. Secondary cooling is then carried out, the duration thereof being equal to a multiple of the duration of an injection moulding cycle. After being removed from the casting moulds, the preforms are dynamically introduced into the cooling sleeves (21) until they fully touch the walls thereof. The inner cooling is carried out in a time-delayed manner.

### TECHNICAL FIELD

The invention relates to a method for the secondary treatment and cooling of preforms after they have been removed from the open mould halves of an injection moulding machine, with the preforms being removed from the open moulds while still hot by means of water-cooled cooling sleeves of a removal device. The invention furthermore relates to a device for the secondary treatment and cooling of preforms after the removal from the upper mould halves of an injection moulding machine by means of water-cooled cooling sleeves of a removal device.

### STATE OF THE ART

In the production of injection moulds, the cooling time is a determining factor for the total time of a full cycle. The main cooling preformance occurs still in the casting mould halves. Both casting mould halves are intensively water-cooled during the casting process so that the temperature of the injection moulds can be lowered already in the forms from approximately 280° C., at least in the border layers, to a range of 70° C. to 120° C. In the outer layers, the so-called glass temperature of approx. 140° C. is passed very quickly. In recent history, the actual casting process up to the removal of the injection moulds could be lowered to about 12 to 15 seconds in the production of thick-walled preforms, and to less than 10 seconds for thin-walled preforms, and this at optimal qualities with respect to the still semi-rigid preforms. The preforms have to set sufficiently in the mould halves so they can be gripped with relatively high force by the ejection aids and transferred to a removal device without deformation and/or damages. The form of the removal device is adapted to the outer dimensions of the injection moulds. For casting mould halves with high wall strength, the intensive water cooling is performed from outside to inside and due to physical reasons with a significant time-delay. This means that the aforementioned 70° C. to 120° C. cannot be reached uniformly across the entire diameter. As a result, there is a quick re-warming over the cross-section of the material from inside to outside as soon as the intensive water cooling is interrupted by the moulds. The secondary cooling is extremely important for two reasons. First, mould changes should be avoided until dimensional stability has been reached, as should damage to the surface, such as pressure points, etc. Secondly, if cooling in the higher temperature range is too slow, it may lead to re-warming and the local formation of damaging crystals, which must be avoided. The objective is an evenly amorphous condition in the material of the finished preform. The residual temperature should be low enough that there is no adhesive damage at the contact points in the relatively large packing drums with thousands of loosely poured parts. Even after a slight re-warming, the injection moulds must not exceed a surface temperature of 40° C. The secondary cooling after the preforms have been removed from the injection mould is as important as the primary cooling in the casting moulds.

U.S. Pat. No. 4,592,719 (Bellehache et al.) proposes to increase the production rate of the preforms by using atmospheric air for the cooling. The air is used as cooling air during the transport and/or the “handling” with maximum cooling effect at the preforms by specifically guiding the flow, on the inside as well as on the outside. A removal device having as many suction pipes as parts produced in an injection cycle enters between the two open mould halves. The suction pipes are then slid over the preforms. At the same time, air starts to flow into the area of the entire circumference of each blow-moulded part through a suction line so that said blow-moulded parts are cooled with the outside air from the moment they enter the suction sleeve. After all of the injection moulds of a casting cycle have been removed, the removal device leaves the travel space of the mould halves. The mould halves are immediately free and are closed again for the subsequent moulding cycle. After the move-out movement, the removal device pivots the preforms from a horizontal into a vertical position. At the same time, a transfer device moves into a precise pick-up position over the removal device. The transfer device has the same number of inner grippers as there are suction pipes on the removal device. In sufficient time after the transfer of all injection moulds and before the mould halves open again, the removal device is pivoted back into its feed position so that the next batch of injection moulds can be removed from the moulds. In the meantime, the transfer device transfers the injection moulds to a transporter and returns to the pickup position for the next batch without the preforms.

With WO 00/24562 (Netstal), which is an older application filed by the applicant, the focus is on the handling, i.e., on avoiding malfunctions such as stuck injection moulds and corresponding double inserts, and thus increasing the productivity at an optimum cooling effect.

The object to be attained by EP 0 947 304 (Husky) was to improve the cooling efficiency and the quality of the preforms and to shorten the entire cycle time. The specification describes first and foremost the problem of crystal formation as a result of poor secondary cooling. It is proposed to cool primarily the inner mandrel part with air with a controlled and automatically guided blast nozzle. The cooling starts immediately after the preforms have been removed from the open mould halves, which is supposed to prevent the local formation of crystals.

U.S. Pat. No. 6,332,770 (Husky) solves the same problem as EP 0 947 304, but with cooling through a local convection cooling effect. A mandrel cooled on the inside is introduced into the inner mandrel area. In doing so, primarily the mandrel area of the preforms is treated with convective cooling. The big disadvantage of the proposal concerning the convective contact cooling by means of a mandrel that can be introduced into the preform is the problem of a precise, automatic mechanical introduction of the mandrel until contact has been made with the respective interior wall surface of the preforms, and furthermore primarily the required precision for the introduction of 100 and more mandrels. The entire machine and all of its movements must be developed with the utmost precision so that each individual preform is contacted in the same way and without pressure damage.

A very interesting solution for the secondary cooling of preforms after they have been removed from the production tool is described in JS-PS 8-103948 (Footier K K). It has been realized that a complete cooling of the preforms still in the production tool prolongs the entire injection cycle. The forms have to be opened much later, thus reducing the productivity extensively. Therefore, a completely separate secondary cooler is proposed for the still hot preforms after they are removed from the production tool. In this way, a high cooling efficiency could be reached with a simple construction. The preforms are transferred to a secondary preform cooler having a corresponding number of cooling pins. In this way, each preform is cooled simultaneously inside as well as outside. The inner cooling is performed through the cooling pins, which have an inside blast air channel. The relative movement for the introduction of the cooling pins is performed automatically by a removal robot. The cooling pins have a blast air opening at the very tip. The air blast is aimed directly vertically to the mandrel-shaped closed bottom of the preforms and can then be guided in opposite direction along the inner wall of the preform and flow out freely at the open end of the preform. This solution allows the shortest possible injection moulding cycle time, a very high efficiency of the overall production, and it prevents any crystallization, in particular in the gate area and thus allows the production of preforms of the highest quality with optimum efficiency.

Each of the solutions shown above has its own advantages. However, these advantages come at the expense of specific limitations or greater efforts. In addition to avoiding the formation of crystals, one important goal in the secondary cooling of preforms is the optimum shape retention. In the scope of secondary cooling, there is the risk that the preforms bend and are no longer completely axially symmetrical. The result may be that individual preforms get stuck in the secondary cooler, thus creating so-called double inserts. This means that a second preform is introduced into the same cooling sleeve. Experience has shown that the complete secondary cooling can be divided into two segments, i.e., in a first phase directly after the removal of the preforms from the mould halves and a second phase in the relatively long secondary cooling. The critical phase is actually the first phase, which has a significant influence on the final quality of the preforms. One important recent finding is that the goal is not to completely prevent the formation of crystals, but rather to keep the crystalline portion in the entire preform to a minimum.

The problem to be solved by the new invention was to optimize the cooling in view of a shortened injection moulding cycle time and to obtain the maximum quality and the smallest possible crystal formation in the preforms without significant process technology efforts or additional expenses for the production of the injection moulding machine.

### REPRESENTATION OF THE INVENTION

The method in accordance with the invention is characterized in that the preforms are subjected to an intensive cooling during the duration of one injection moulding cycle, which includes the entire inside as well as the entire outside of the blow-moulded part, followed by a secondary cooling that is a multiple of the duration of one injection moulding cycle, with the preforms being introduced dynamically after the removal from the casting moulds until they fully touch the wall of said cooling sleeves and the inner cooling is carried out in a time-delayed manner.

The device in accordance with the invention is characterized in that it has a station for intensive cooling as well as a secondary cooling station, and the intensive cooling station has cooling pins which can be introduced into the inside of the preforms for an inner cooling, with the inner form of the cooling sleeves being adapted to the corresponding inner form of the casting moulds in such a manner that the preforms can be introduced into the cooling sleeves without play, if possible, after they are removed from the casting moulds until they fully touch the walls of said cooling sleeves.

Experience has shown that the first secondary cooling phase is especially critical because the preforms are not yet dimensionally stable. The risk that the blow-moulded part “bends” slightly from the threaded axis relative to the threaded part is indeed a genuine problem in the phase of removing the preform in laying position with horizontally operating injection moulding machines. This applies in particular if the cooling time inside the injection moulds has been reduced to a minimum and the preforms are still relatively hot and correspondingly soft. If the preforms are in laying position in the first phase of the secondary cooling, they tend to lay downward on the appropriate part of the cooling sleeve. With a better cooling contact in the lower part, the cooling sleeve is cooled stronger in the lower part, causing strains in the preform and a tendency of bending in the preform. If individual preforms suffer slight deformation in the first phase of the secondary cooling during shortened cooling in the casting moulds, the resulting deformation can no longer be corrected in the increasingly set preforms.

The new invention proceeds primarily from the cooling concept where the individual preforms are introduced into the cooling sleeves only with the blow-moulded part during the secondary cooling. In doing so, the threaded parts project past the cooling sleeves. This has the enormous advantage that the preforms are inserted into and removed from the cooling sleeves of the removal device in a linear movement. The new solution proposes an optimal contact with the cooling sleeve in particular in the phase of intensive cooling immediately following the removal from the casting moulds and in this way achieves a quick, maximally intensified temperature drop and stabilization of the preforms in the first secondary cooling phase for the subsequent final cooling. The dynamic introduction of the preforms until they fully touch the walls in the cooling sleeves immediately following the removal of the preforms from the casting moulds, but before the longer final cooling, has significant advantages:

For physical reasons, the cooling effect is the highest when the temperature difference between the hot preforms and cooling sleeves is the highest immediately following the removal from the casting moulds. This is where the forced, flush and full-area contact between the preforms and the inner area of the cooling sleeves results in the optimum gain because of the optimized thermal conduction. Thus, the formation of crystals is reduced to a minimum. After the preforms are removed from the casting moulds, said preforms, which are still hot, are introduced into a cooling sleeve with as little play as possible to retain the geometrical accuracy. The preform that is cooled quickly after removal thus retains geometrical accuracy with respect to the symmetry in the subsequent handling.

The first pressing tests already showed that the new solution allowed for a shorter injection cycle time of half a second while completely retaining the quality parameters, which corresponds to an approximately 5% increase in productivity. This is because the preforms are removed from the moulds at a higher temperature, and thus more quickly than with the state of the art. In the very first phase of the secondary cooling, the contact of the still soft blow-moulded part at the inner wall of the cooling sleeves is possible with minimal compressed air forces.

With the new invention, the inner cooling with the cooling pins can be performed with suction air and/or compressed air, with suction air and compressed air being turned on and off through control valves. It is in particular preferred to carry out the inner cooling by means of cooling air with cooling pins arranged on a controllably movable supporting plate, which are introduced synchronically into the inside of the preforms after the removal device has completely moved out and with the cooling air being actively blown in and/or suctioned off. The movement of the cooling pins is carried out synchronously in the timely rhythm of the injection moulding cycle and the introduction movement is performed with power control and/or displacement control.

The inner diameter of the cooling sleeve is selected at most a few hundredths of a millimeter larger than the outer dimensions of the still hot preforms. With the direct control of the suction—and/or compressed air, a swelling pressure can be created, and the preform can be brought into complete contact with the entire inner wall area of the cooling sleeve. After the first contact between the preforms and the inner wall area of the cooling sleeves, the surface contact is maintained for several seconds to maximize the cooling effect. At the same time, a calibration effect is generated for each individual preform. In the production of preforms, the calibration effect allows for a production—and quality standard that was not possible in the scope of the state of the art. Shortly after they are removed from the casting mould, the preforms are again pressed into an exact mould so that any dimensional changes after the first critical handling from the casting moulds into the cooling sleeves, in particular a bending of the preforms due to one-sided contact in the cooling sleeve, can be eliminated. With the calibration effect, the preforms can be removed from the moulds even earlier and thus a shorter casting cycle time, as well as an improved first phase of the secondary cooling, can be achieved. This is very advantageous in particular in view of the quickest possible passing through the glass temperature and thus the damaging formation of crystals. The subsequent secondary cooling is less problematic with respect to all qualitative parameters and can be performed in the required time, preforms of the highest quality are produced, and at the same time, the productivity of the injection moulding machine can be increased. The invention allows several embodiments as well as a number of advantageous modifications. Reference is made to the claims 5 to 9 as well as 11 to 22 in that regard.

An especially advantageous first embodiment is characterized in that a slight swelling pressure is generated through the cooling pins. In view of the best possible thermal transition between the preforms and the inner wall area of the cooling sleeves, the objective is to introduce the preforms into the cooling sleeves without play, if possible. A solution in the state of the art is to develop the preforms conically on the outside, with the preforms being only introduced partially initially, pulled in gradually with appropriate negative pressure at the opposite side, and good wall contact with the cooling sleeve is maintained over the entire duration of the secondary cooling time. The big disadvantage is that the bottom parts of the preforms are cooled only very poorly from the outside. With the new solution, the complete introduction is performed dynamically with no time delay, if possible, i.e. essentially within seconds. The wall contact can be maintained during the remainder of the intensive cooling with the slight swelling pressure. To generate the swelling pressure, each cooling pin has blast air openings and is placed with a slight seal relative to the respective preform. The blast air and the suction air are controlled so that a slight excess pressure is generated in each preform during the intensive cooling, and the preform is pressed to the inner walls of the cooling sleeves and thereby calibrated.

An important goal of the new solution is that the cooling application is carried out gradually during the intensive cooling. The temperature differences that still exist in the preforms are eliminated as quickly as possible after removal from the casting moulds. At the same time, it is possible to lower the crystalline parts in the entire preform to the lowest possible value, with the preforms being brought into a completely dimensionally stable condition for the subsequent secondary cooling. If the preform already has the best possibly symmetry relative to the entire outer form at the beginning of the secondary cooling, the risk of so called “double inserts” resulting from bent preforms and the corresponding operational malfunctions can be ruled out with near certainty.

According to a second embodiment, the inner cooling is performed by means of suction air through cooling pins arranged on a transfer gripper, which are introduced synchronously into the interior of the preforms after the removal device is moved out completely, with suction air remaining active after the intensive cooling during the transfer of the preforms from the removal device to a separate secondary cooling station until the preforms are transferred to the secondary cooler. During the intensive cooling, each cooling pin remains connected to a vacuum pump that actively suctions off warmed cooling air through the cooling pin. The intensive inner cooling is maintained for at least 2 to 7 seconds of cooling time and/or approximately 3% to 10% of the secondary cooling period until sufficient firmness of the outer skin of the preform. The intensive cooling is only a fraction of the entire secondary cooling. During the intensive cooling, the temperature is lowered on the average by 20 to 40° C. A severe prolonging of the intensive cooling phase is not advantageous because the thermal travel within the preform material cannot be increased.

The cooling pin is developed tubular and has a suction opening at the very tip of the cooling pin, with the cooling pin being introduced far enough into the preform for the intensive cooling so that an open gap for the suctioning of the cooling air remains opposite to the inner mandrel-shaped preform bottom. All cooling pins are part of a supporting plate that can be connected to a vacuum source to suction off cooling air from the interior of the preform. The cooling pins have a casing developed as a base, which on the one hand has blow-out openings for the cooling air and on the other hand can be connected to a compressed air source through the supporting plate, with the casing preferably being guided over less than half of the length of the suction pipe. The supporting plate is developed with two chambers, i.e., a first chamber connected to a compressed air source, with the suction pipe being guided through the second chamber and the first chamber being connected directly to the space between the casing and the suction pipe. Controllable valves are arranged for the suction air as well as for the blow air to optimize the usage. During the phase of the intensive cooling, the suction—as well as the blow air is activated. The zero compression point can be determined by selecting the pressure and the quantity on the suction side as well as on the compressed air side. Optimally, the zero compression point is determined in the suction pipe so that the entire interior space of the preform can be placed under a slight overpressure and thus the calibration effect mentioned earlier is generated.

The new solution has a removal device with cooling sleeves, and a supporting plate of the transfer gripper with a cooling air connections [sic], which can be moved to a tight fit relative to said removal device. According to the number of cooling sleeves, the supporting plate is equipped with cooling pins and sealing rings, which form a seal to one each preform in the inside of the preform to generate a slight swelling pressure on the inside of the preforms. The sealing location is arranged relative to the open end of the preforms and becomes effective only at the end of the introductory movement of the blow mandrels. Preferably, the sealing location is established with a soft packing between the individual cooling pins and the outer edge of the threaded part of the preforms and the edge of the threaded part is held by the elastic sealing.

A third embodiment is characterized in that the device for an interior cooling has cooling pins of a controlled, displaceable supporting plate which can be introduced into the preforms, with the individual cooling pins being developed to yield into the direction of the introduction movement with respect to the preforms so that each cooling pin can be introduced with controlled force until it establishes contact with the inner mandrel part of the preforms. The cooling pins can be developed as blow mandrels and have a movably arranged contact head and a continuous air boring to the contact head, which runs into a blast air chamber between the blow mandrel and the contact head and is variable in size. Advantageously, each cooling pin has a compression spring to generate a controlled pressing power. The cooling pins are developed with a contact cooling head for the mechanical contacting and contact cooling of the corresponding interior mandrel part of the respective preform, with the controlled power being generated through blast air and/or a compression spring. The contact head is preferably developed like a sleeve to move freely on the cooling pin between a maximally extended and retracted position.

As the simplest and most cost efficient structural design, each cooling pin has a movably arranged contact head. In this way, a continually run blast air boring is provided for each of the cooling pins up to the contact head, which runs into a blast air chamber that is variable in size. Each contact head is arranged on the cooling pin to move freely like a sleeve between a maximally extended and retracted position, with the extended position being created by the blast air and/or a compression spring and the retracted position being created by negative pressure. In the area of the tip of the contact, the contact heads can have at least one blast air opening that is connected to the blast air chamber. The tip of the contact can be developed integrally in the gate area of the preform for a completely mechanical contacting of the appropriate innermost part of the mandrel part of the respective preform. Each cooling pin advantageously has a blast mandrel base that can be fixedly attached to the supporting plate and has a tunnel-shaped extension in the direction of the blast air, with the contact head being moveable relative to the tubular extension. The contact head and the base of the blast mandrel are developed at least somewhat cylindrically to create a gap between the cylindrical forms and the interior of the preform to increase the rate of the discharged blast air. Cross-borings may be arranged in the area of the base of the blast mandrel, which can be attached to a vacuum source to ensure a safe removal of the preforms from the cooling sleeves and the transfer to the actual secondary cooler.

The new solution has a secondary cooling station as well as an intensive cooling station, and the inner side of the preform as well as the outer side of the preform can be intensively cooled in the intensive cooling station within the duration of one injection moulding cycle. The intensive cooling station can be developed as a structurally independent controllable removal station or as part of a secondary cooler having a number of cooling sleeves that corresponds to several batches of one injection moulding cycle, in particular preferably four batches. The complete secondary cooling has a control to control all movements for the handling of the preforms and the cooling pins as well as for a cyclically pulsed use of compressed air and suction air, furthermore a removal robot with cooling sleeves, a transfer gripper and the supporting plate with controllable movements relative to the cooling pins, with the preforms being transferred by the transfer gripper following intensive cooling in the cooling sleeves of the transfer robot for complete cooling in the secondary cooler.

Another advantageous embodiment is characterized in that the cooling sleeves that are water-cooled on the outside have an inner form that corresponds to the outer form of the preform including the convex bottom part, and the cooling sleeve including the convex bottom part is developed as thin-walled as possible so that a maximum thermal conduction and/or thermal transfer is established across the entire cooling sleeve and from the cooling sleeve to the outside of the preform during the brief contact.

Depending on the strength of the wall, the casting cycle lasts 10 to 15 seconds and the complete cycle including the complete secondary cooling lasts 30 to 60 seconds. However, the operating efficiency of the machine is determined by the casting cycle time. The calibration occurs during the first phase of the secondary cooling, with 1 to 10 bar of compressed air being blown in in a first phase to generate sufficient swelling pressure, for example 0.1 to 0.2 bar.

Preferably, the cooling of the preforms is not interrupted between removal from the mould halves until the cooling is completed. The cooling pins have an elastomer sealing ring. This ensures that there are no deformation forces acting on the threaded part.

Advantageously, a local cooling and hardening of the surface, which is directed in a first phase towards the open end of the thread as well as the bottom part of the preform, is generated during the introduction of the cooling pins as well.

The new solution separates the secondary cooling into two independently controllable phases:
a first intensive cooling is limited to the duration of a casting cycle. The intensive cooling occurs while the next moulding cycle is underway, over a time period of 5 to 15 seconds, for example.
The actual secondary cooling requires a time equal to a multiple thereof, usually about three—to four times the injection moulding cycle. This is where an intensive cooling does not make sense economically because thermal travel cannot be influenced significantly within the wall strengths of the preforms.

The new solution proposes to take advantage of various cooling interventions:
Interior cooling with air as well as with contact cooling, if applicable
Exterior cooling by means of water-cooled cooling sleeves,
   as well as a mechanical solution which, in the case of a mechanical contacting of the mandrel-like inner preform side, can be developed yieldingly instead of rigid. This will provide a maximum of efficiency and quality in the shortest possible time and the problem can be solved with relatively few additional structural efforts.

### BRIEF DESCRIPTION OF THE INVENTION

The invention is described in the following with a number of embodiments and additional details. They show:

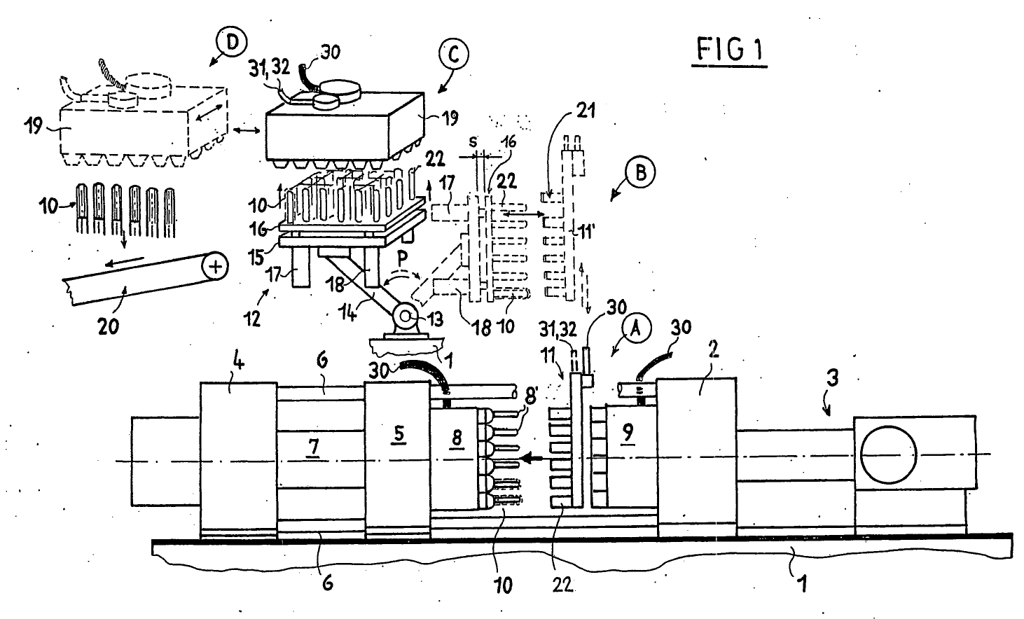

FIG. 1 a schematic overall view of an injection moulding machine for the production of preforms with a removal device as well as a transfer gripper equipped with a number of cooling pins;

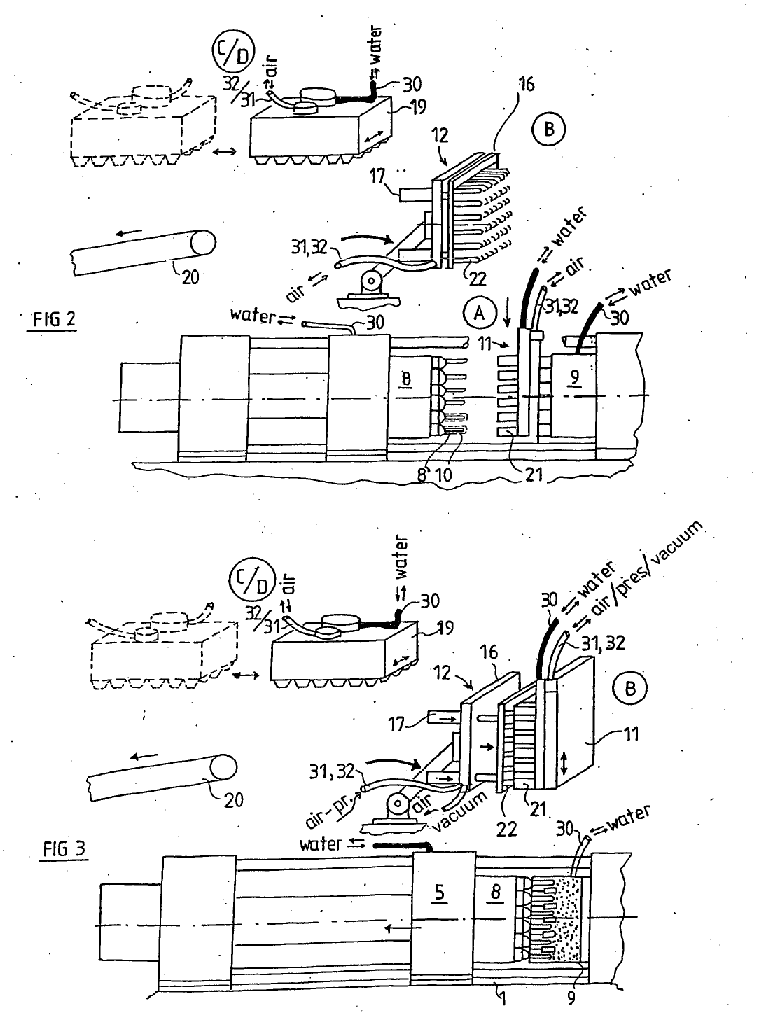

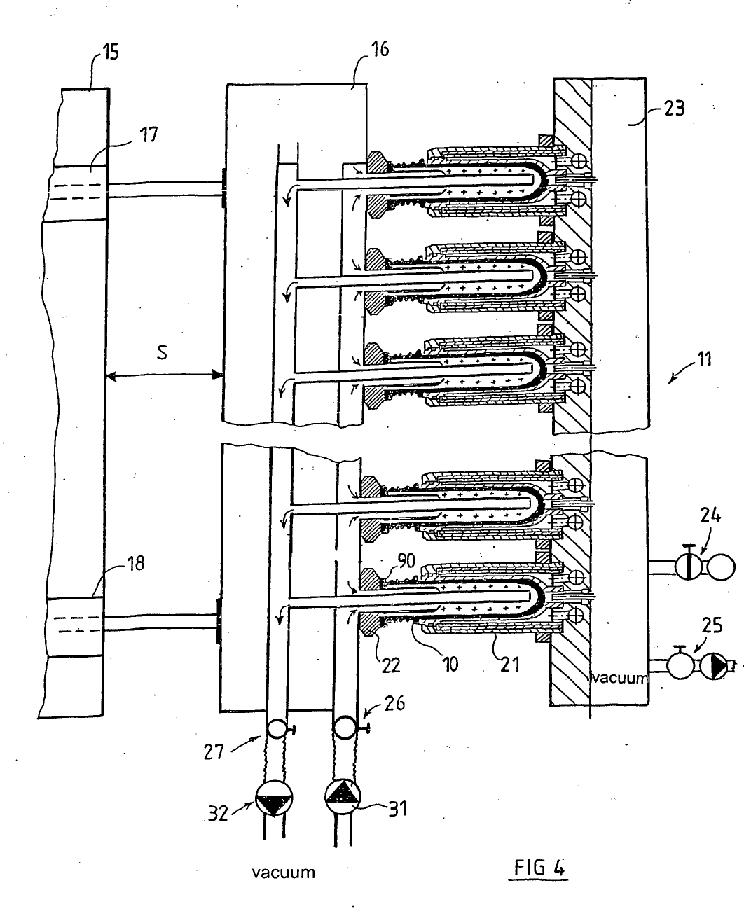

FIGS. 2 and 3 each a step after the end of the injection cycle; In FIG. 2, the removal device removes the still hot preforms from the open mould halves. FIG. 3 shows the moment of the intensive cooling of the preforms;

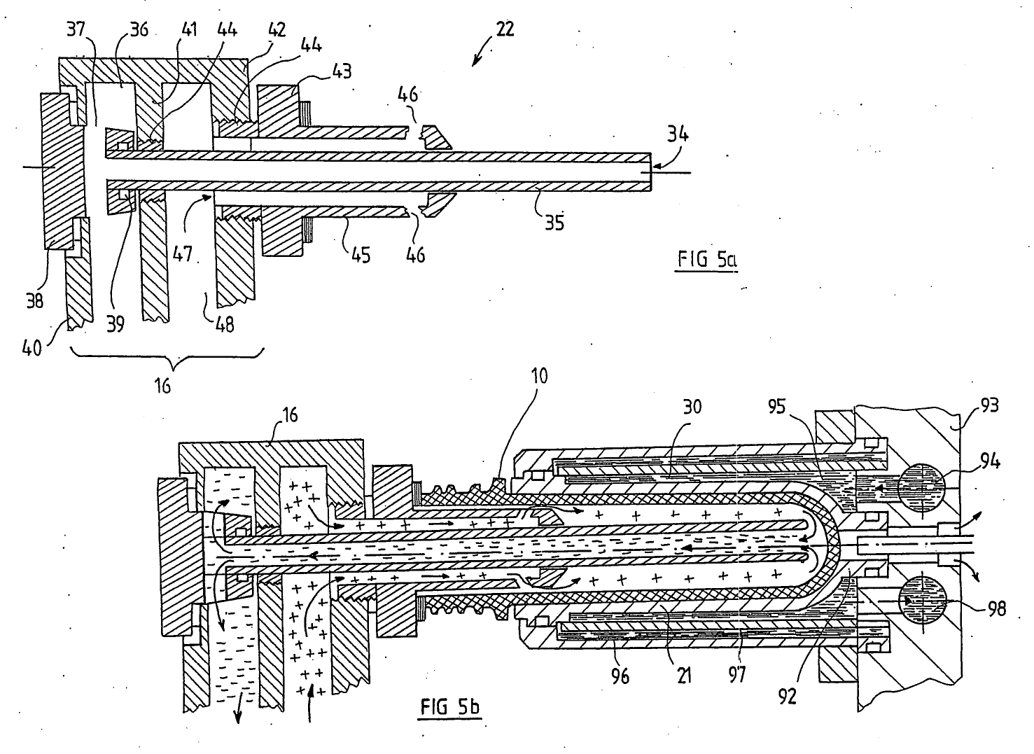

FIG. 4 a sectional overview of the phase of intensive cooling in the removal device;

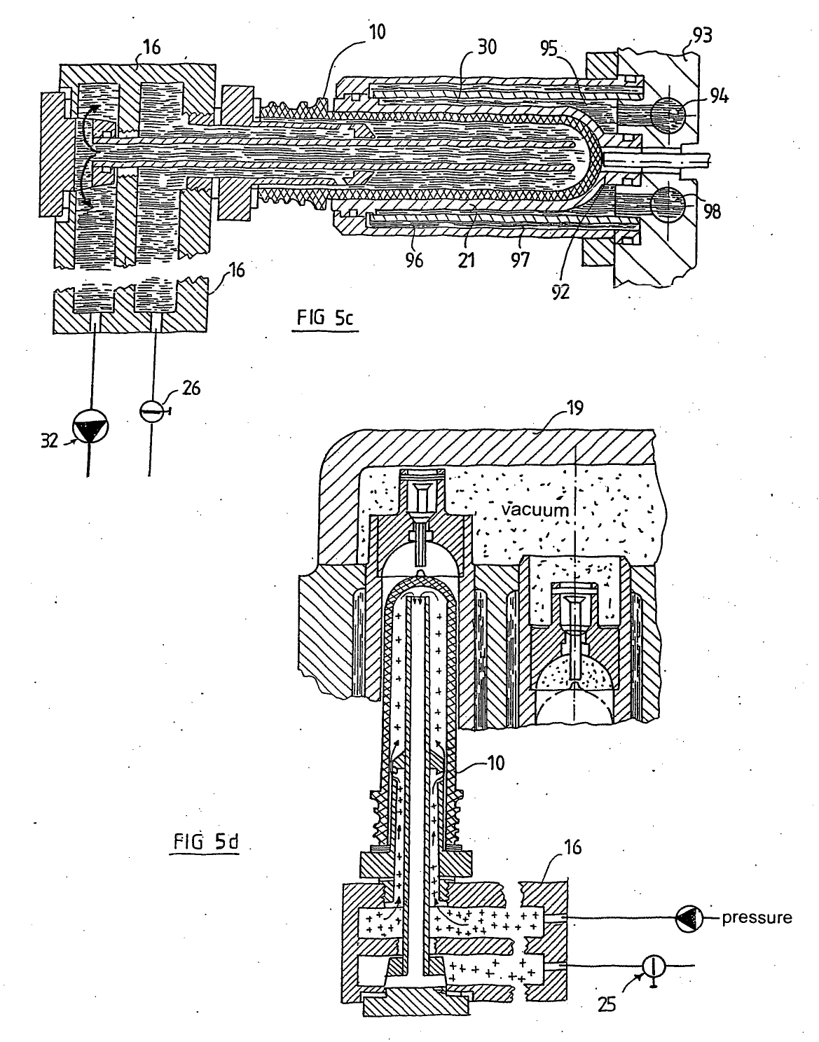

FIG. 5a an embodiment of a cooling pin with closed contact head;

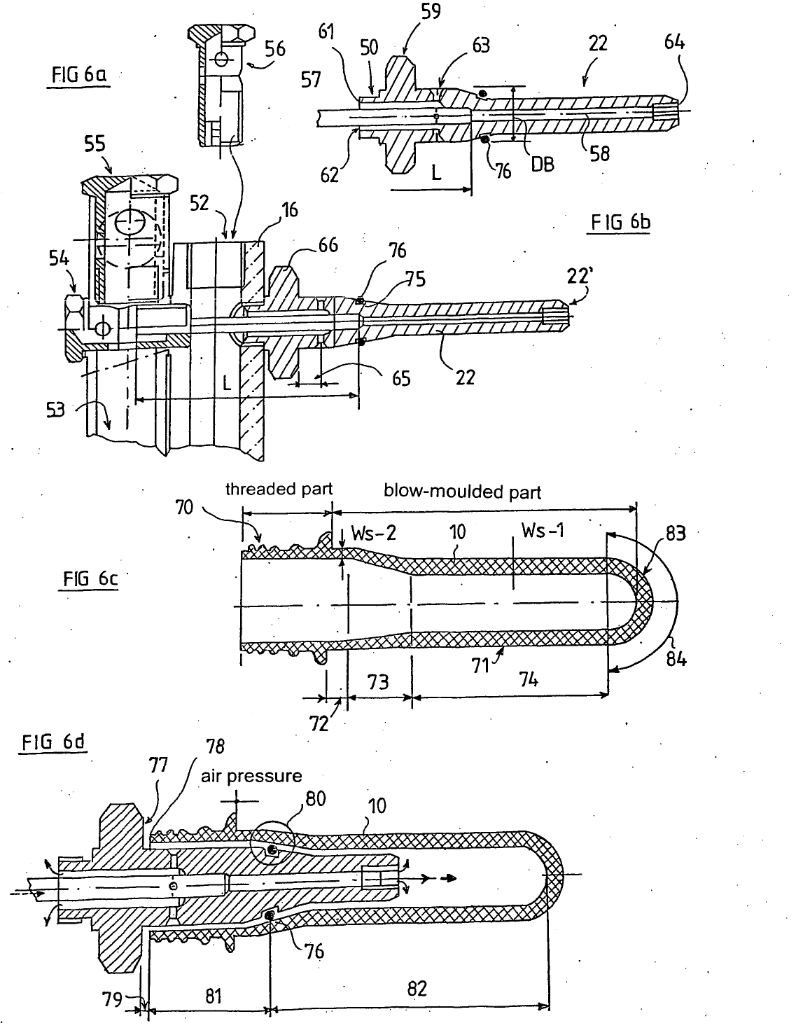

FIGS. 6a to 6d a cooling pin as blast air nozzle, developed in various situations such as a segment of the supporting plate with a blast air nozzle in FIG. 6a, a single blast air nozzle in FIG. 6b, a preform in FIG. 6c and the blast air nozzle in calibration position in FIG. 6d;

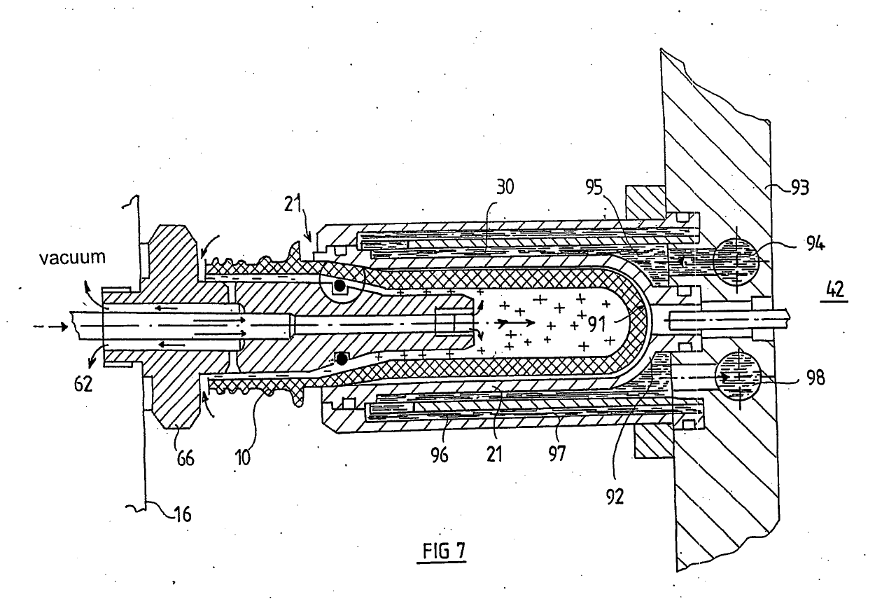

FIG. 7 an example of a situation in the phase of actual calibration of an individual preform;

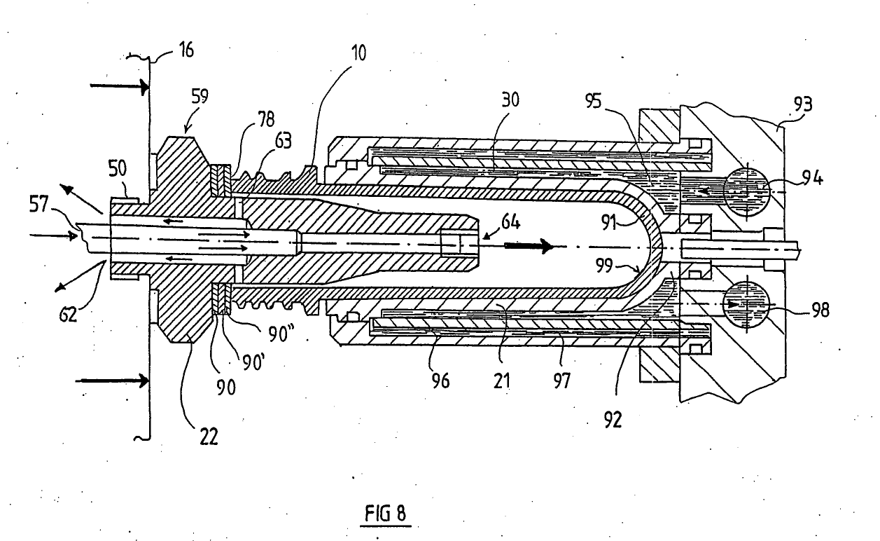

FIG. 8 an optimized solution with respect to the calibration of a preform as well as the modification of a water-cooled cooling sleeve with respect to thermal transfer and/or heat transmission;

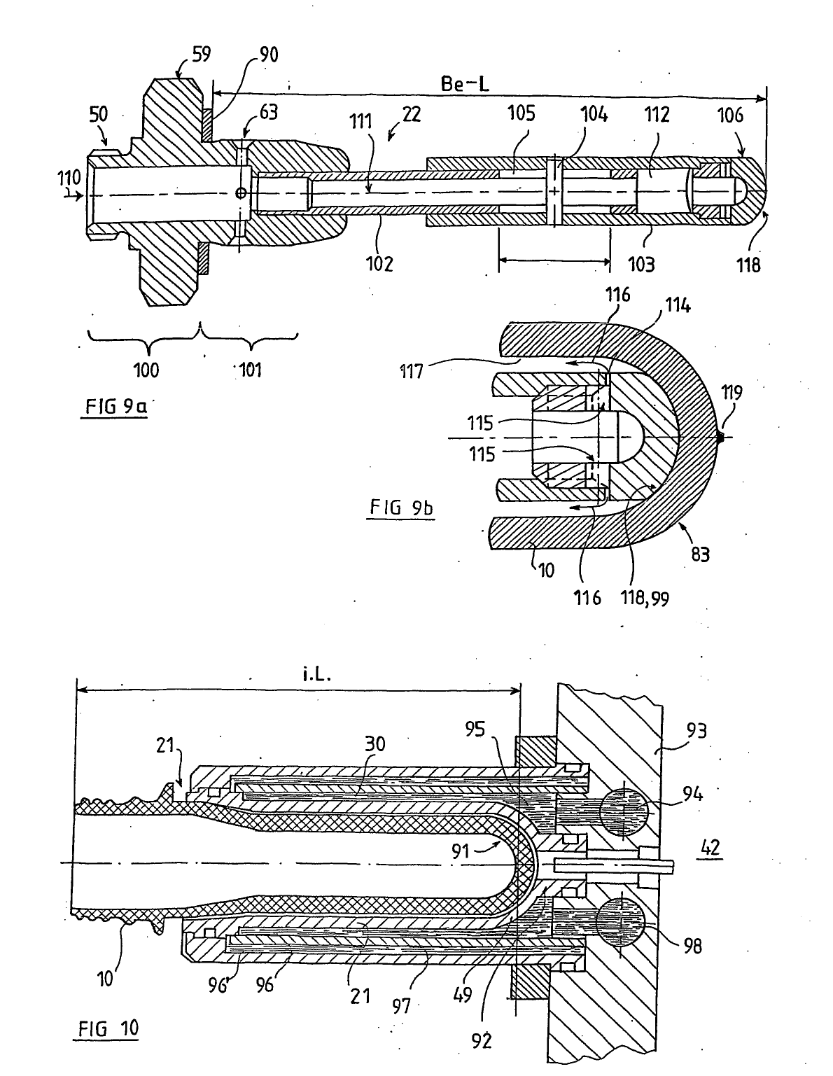

FIG. 9a an embodiment for a cooling pin with closed contact head;

FIG. 9b the contact head of the cooling pin in FIG. 9a;

FIG. 10a single cooling sleeve, shown in a large scale;

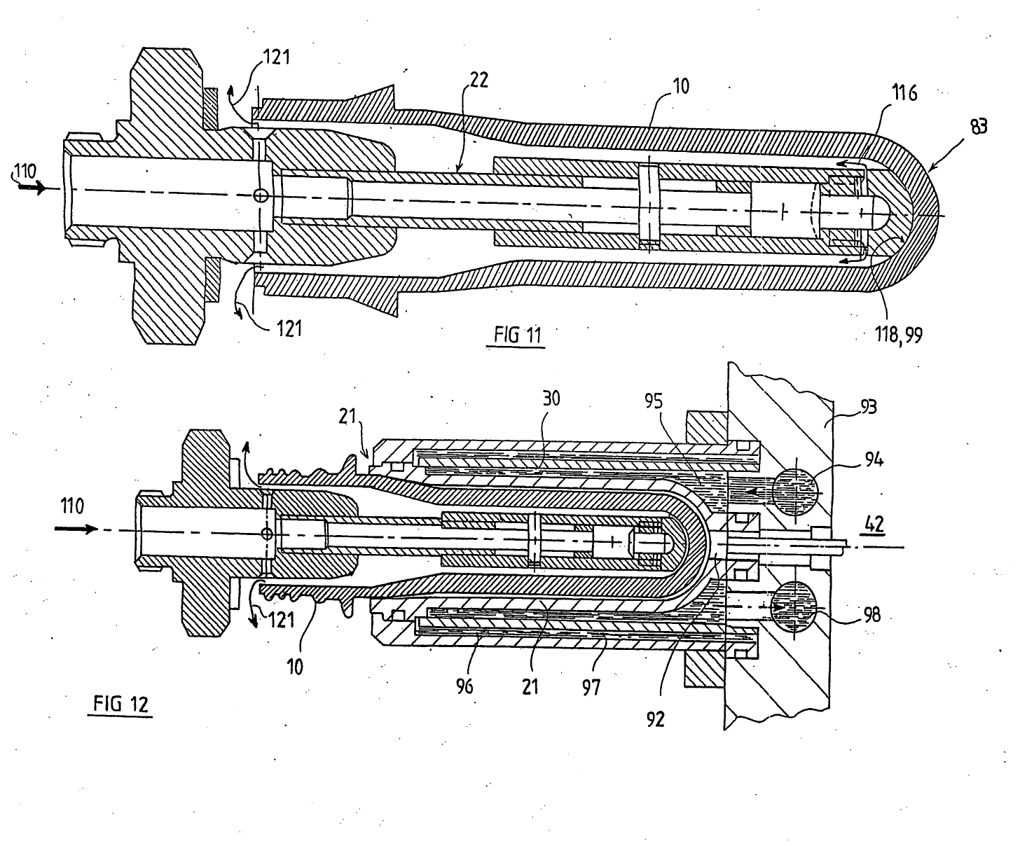

FIG. 11 a cooling pin and a preform;

FIG. 12 a cooling pin in cooling position inside a preform and/or a cooling sleeve;

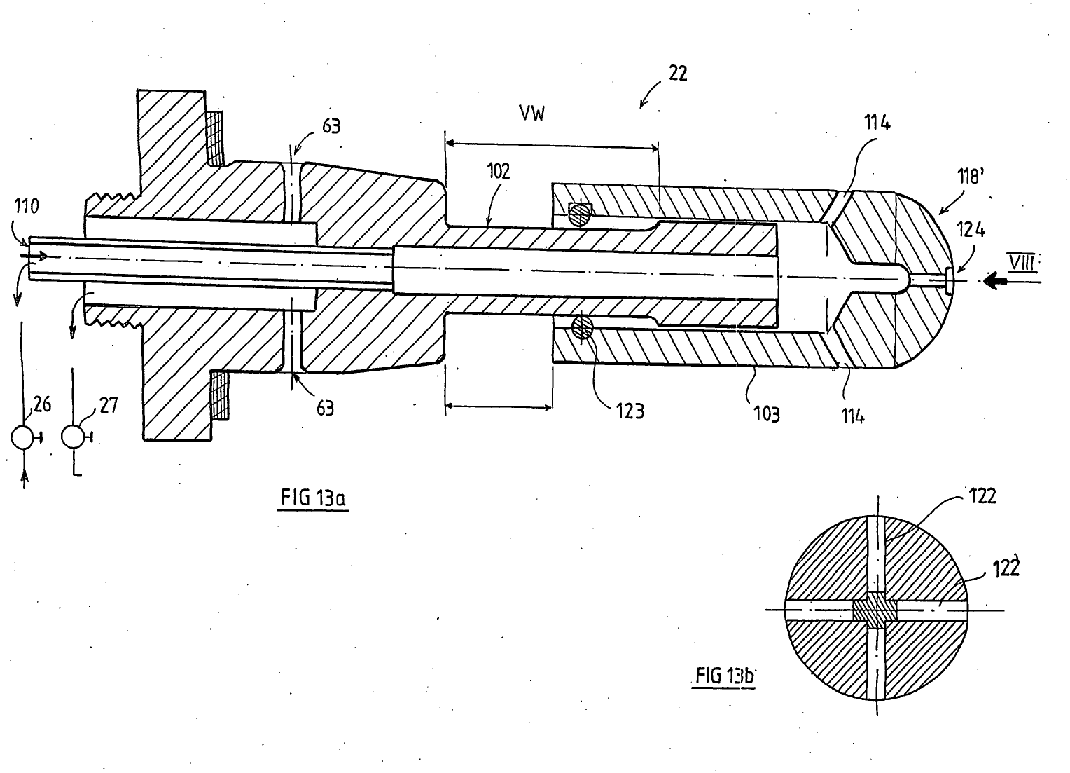

FIGS. 13a and 13b another embodiment of a cooling pin, and FIG. 13b a view in the direction of arrow VIII of FIG. 13a;

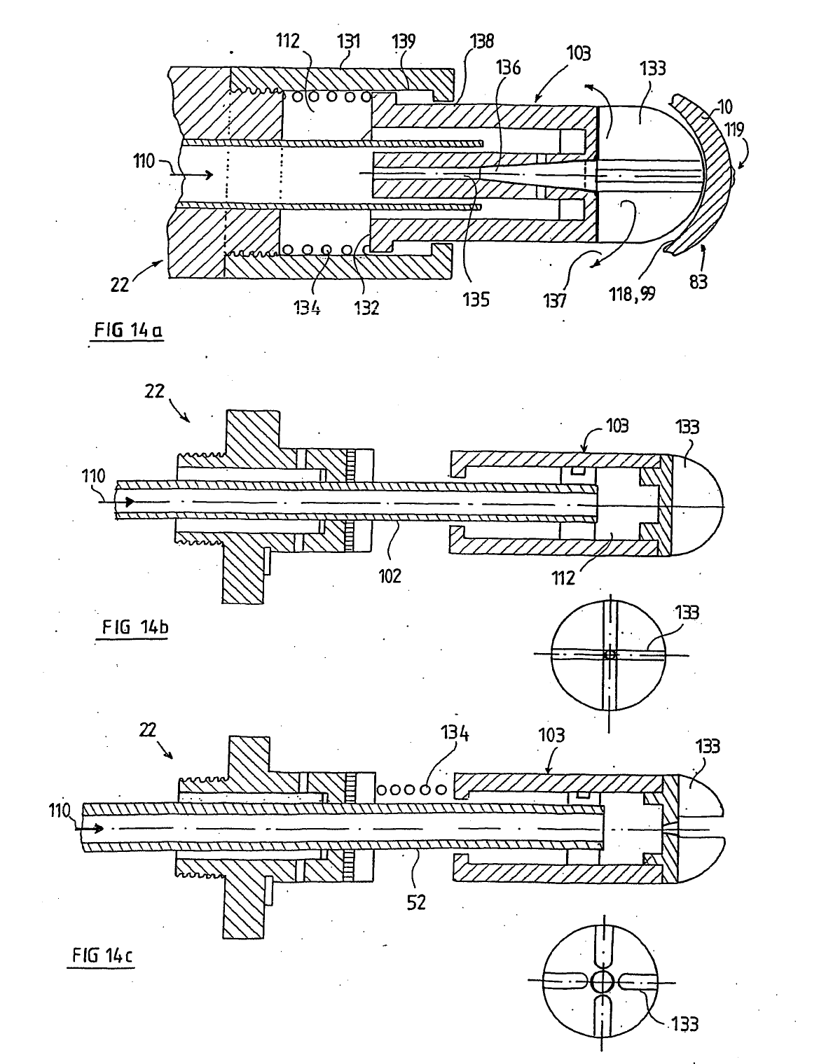

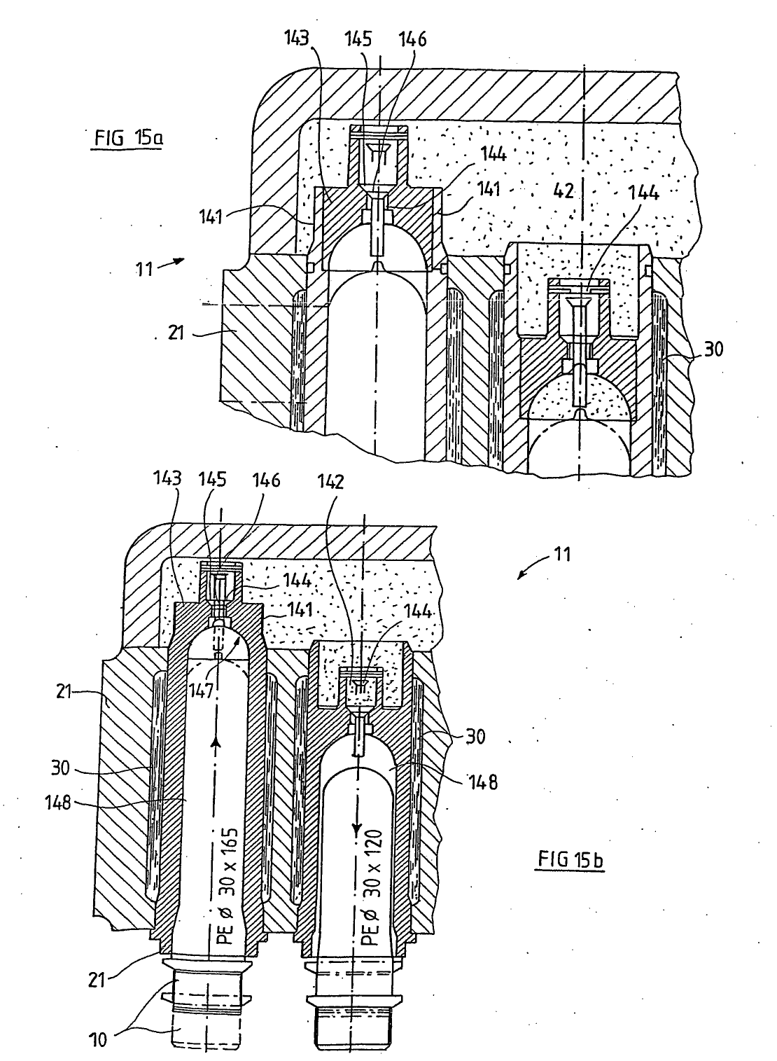

FIG. 14a a cooling pin developed as blast mandrel;

FIGS. 14b and 14b each show a different modification according to the solution in FIG. 14a;

FIGS. 15a and 15b a cooling pin with a central suction pipe with contact head;

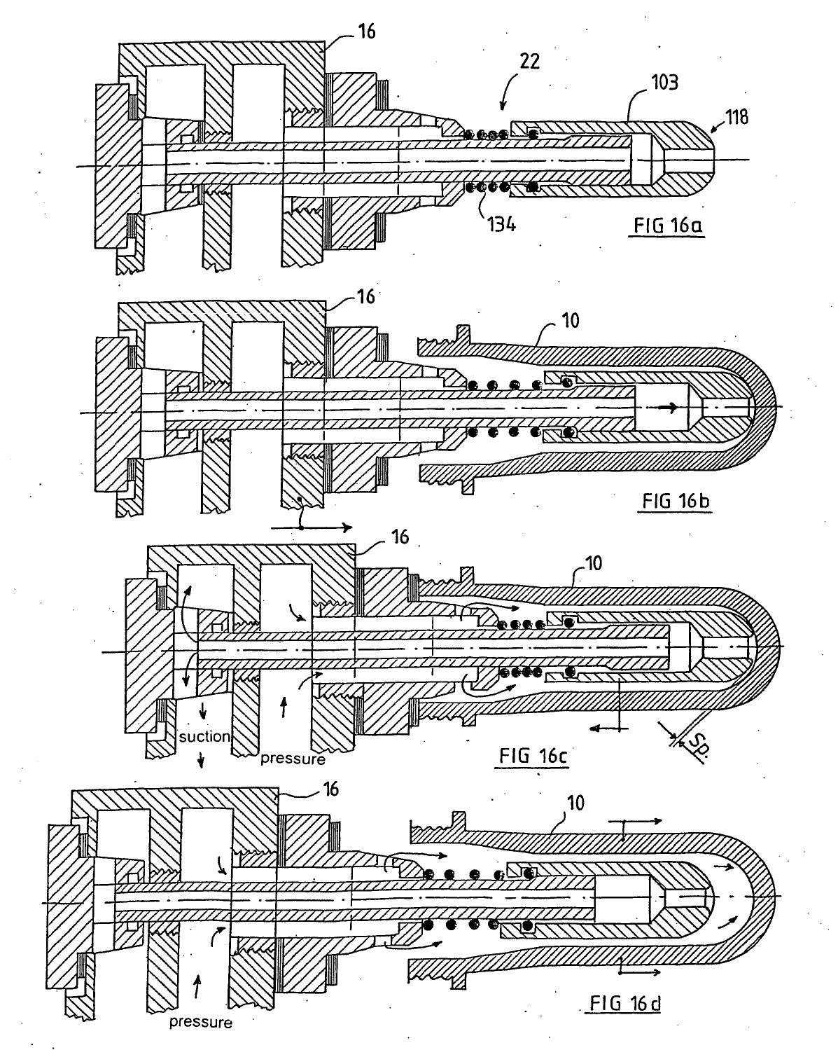

FIGS. 16a to 16d various situations with a blow-suction solution with downstream contact head;

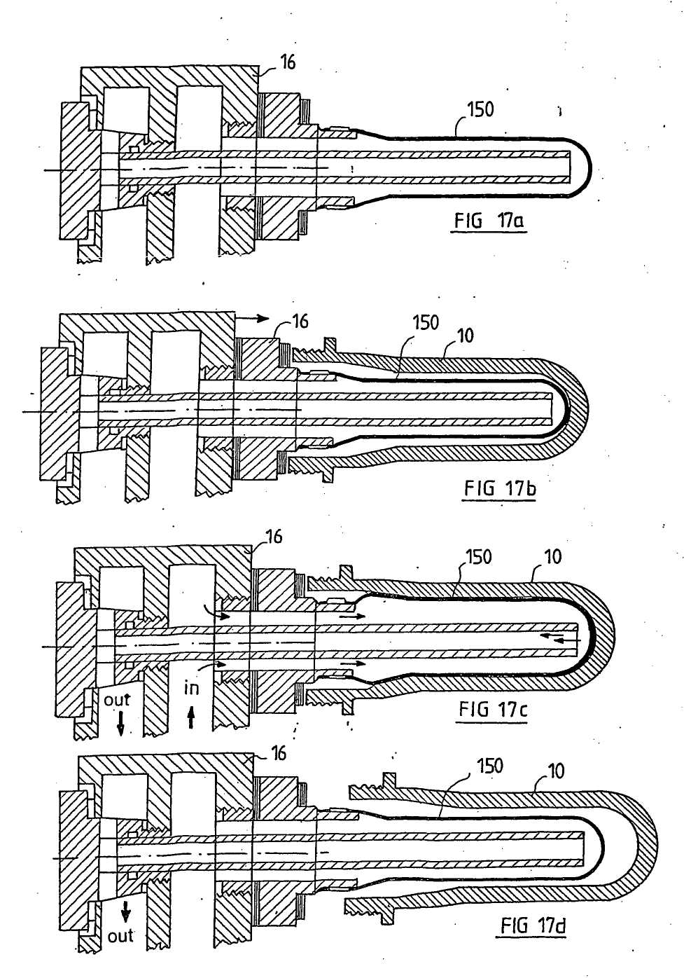

FIGS. 17 to 17d a solution with an expandable mandrel casing to calibrate and cool the inner side of the preform.

### METHODS AND DEVELOPMENT OF THE INVENTION

FIG. 1 shows a complete injection moulding machine for the production of preforms, having a machine bed 1 which supports a fixed mould clamping plate 2 and an injection unit 3. A supporting plate 4 and a movable mould clamping plate 5 are axially movable and supported on the machine bed 1. The fixed mould clamping plate 5 and the supporting plate 4 are connected by four tie bars 6, which intersperse and guide the movable mould clamping plate 5. A drive unit 7 is located between the supporting plate 4 and the movable mould clamping plate 5 to generate the clamping pressure. The fixed mould clamping plate 2 and the movable mould clamping plate 5 each carry a mould half 8 and 9, with a plurality of partial moulds 8′ and 9′ being arranged in each of said mould halves 8 and 9. Together, said partial moulds form the cavities for generating an appropriate number of sleeve-shaped injection moulds and/or preforms. The partial moulds 8′ and 9′ are developed as mandrels, and the sleeve-shaped preforms 10 adhere to said mandrels after the mould halves 8 and 9 are opened. At that time, the injection moulds are still hot and thus in a semi-rigid condition, which is indicated with dashed lines. The same injection moulds 10 in completely cooled condition are shown on the top left in FIG. 1, where they are about to be ejected from a secondary cooling means 19. For a better representation of the details, the upper tie bars 6 are shown in dashes between the opened mould halves. A to D show the various stages of secondary preform cooling.
“A” is the removal of the injection moulds or preforms 10 from the two mould halves. The sleeve-shaped parts, which are still semi-rigid, are picked up by means of cooling sleeves 21 by a removal device 11 lowered into the space between the open mould halves into the Position “A” and lifted with said removal device into the pick-up position “B”.
“B” is the phase of intensive cooling, with the cooling pins and/or blast mandrels 22 being held on a controllably movable supporting plate and inserted into the preforms 10 (FIG. 2b).
“C” is the transfer of the preforms 10 from a transfer gripper 12 to a secondary cooling means 19.
“D” is the drop of the cooled preforms, which are now completely dimensionally stable, from the secondary cooling means 19.

FIG. 1 shows the main steps for the handling of the preforms. The sleeve-shaped preforms 10, which are arranged in a vertical stack, are picked up by a transfer gripper 12 and/or 12′ and moved into a horizontal side-by-side position according to phase “C” by pivoting the transfer means 12 into the direction of the arrow P. The transfer gripper 12 is comprised of a holding arm 14 that can pivot around an axis 13 and supports a holding plate 15; a supporting plate 16 for the cooling pins 22 is arranged in parallel distance to said holding plate 15. The supporting plate 16 can be opened parallel to the holding plate 15 according to the arrow by means of two steerable and controllable servo motors 17 and 18 so that the sleeve-shaped injection moulds 10 are taken out of the removal device 11 in position “B” and placed into the secondary cooling means 19 above it after being pivoted into position “C”. The respective transfer is performed by increasing the space between the holding plate 15 and the supporting plate 16. The cooling of the preforms 10, which still have a temperature of over 70° C., is completed in the secondary cooling means 19. After a displacement in the secondary cooling means 19, said preforms are ejected in position “D” and dropped onto a conveyer belt 20. The pivoting movement of the transfer gripper, the linear loading movement for inserting the cooling pins, and the lateral—and longitudinal displacement of the secondary cooling means are performed by the electric servo drive so that the timing and path of each movement can be controlled with optimum precision. The servo motors can be steered/controlled with respect to path and speed as well as power so that the handling and in particular the introduction movement can be performed with the highest precision and accuracy.

The greatest temperature drop in the injection moulds 10 from approximately 280° C. to 120° C. occurs still within the closed moulds 8 and 9, and an enormous through-put of cooling water must be ensured for this purpose. The removal device 11 is represented in dashes in a holding position, which indicates the end of the injection phase. The reference symbol 30 indicates the water cooling with the appropriate feed—and drain lines, which are shown in arrows for simplification; it is assumed that these are known. The reference symbol 31/32 indicates the air side, with 31 indicating the feed-in of blast air and/or compressed air and reference symbol 32 indicating a vacuum and/or suction air. In the injection moulds 8 and 9, the preforms are cooled simultaneously on the inside and outside while still in the injection cycle. Initially, only the outside is cooled in the cooling sleeves of the removal device 11. Another interesting issue is the handling in the area of the secondary cooling means 19. During the removal phase “A”, the secondary cooling means can be displaced independently horizontally according to arrow L from a pickup position into a drop position (shown in dashes). The secondary cooling means 19 has a multiple of capacity compared to the number of cavities in the injection mould halves. The drop of the completely cooled preforms 10 is therefore performed only after two, three or more injection moulding cycles so that the secondary cooling time is extended accordingly relative to the casting cycle. For the transfer of the preforms from the transfer gripper 12 to the secondary cooling means 19, the latter can be additionally displaced transversely and moved into the proper position.

FIGS. 2 and 3 also schematically show two situations with the respective cooling intervention means. FIG. 2 shows the start of the removal of preform 10 from the mould halves. Not shown are the auxiliary means for the ejection of the semi-rigid preforms from the partial molds 8′. The supporting plate 16 with the cooling pins 22 is in retracted position. FIG. 3 shows the two mould halves 8 and 9 again in closed condition, i.e., in the actual casting phase. Furthermore, FIG. 3 shows a situation for the core function of the new solution. The transfer gripper 12 is in the position according to FIG. 2, with the supporting plate 16 and the cooling pins 22, however, being shown in retracted position. The cooling pins 22 are completely introduced into the cooling sleeves 21 while the preforms are cooled intensively in the cooling sleeves. The remainder of the secondary cooling takes place in the secondary cooling means only after the preforms have been removed dimensionally stable from the removal device by the transfer gripper and are inserted into the secondary cooling means.

FIG. 4 shows the phase of intensive cooling. Only five cooling positions are shown as an example. During the phase of intensive cooling, the preforms 10 are cooled on the outside as well as on the inside. In this phase, the preforms are continually held or attracted to the inner bottom part of the cooling sleeves through negative pressure in space 23 of the removal device 11. FIG. 4 shows the use of blast air and suction air through two separate air systems. Only five cooling positions are shown as an example. During the phase of the intensive cooling, the preforms 10 are cooled on the outside as well as the inside. In this phase, the preforms are held and/or attracted continually to the interior bottom part of the cooling sleeves by negative pressure in space 42 of the removal device 11. As needed, the space 23 can be switched from negative pressure to overpressure through the valves 24/25. Negative pressure is maintained continually during the phase of intensive cooling to keep the preforms truly pulled in. The pressure is switched to overpressure at the end of the intensive cooling so as to eject the preforms with the compressed air. At the inner side of the preforms, air is suctioned off by a connected vacuum source during the phase of the intensive cooling as well as the transfer, which pulls the preform on a seal of the cooling pins. The compressed air valve 26 is opened and the vacuum valve 27 is closed to transfer the preforms to the secondary cooling means.

FIG. 5a shows a cooling pin 22 on a larger scale. The concept of the cooling pin proceeds on the assumption that cooling air is suctioned off at the orifice 34 of a suction pipe 35. For this purpose, the suction pipe 35 is connected to a negative pressure chamber 36 of the supporting plate 16 through a connection opening 37. The suction pipe 35 is guided into a sealing screw 38 and sealed through an O-ring 39. The supporting plate 16 is constructed in 3 shadow-like fashion with 3 rear wall 40, a center wall 41 and a front wall 42. The negative pressure chamber 36 is formed by the rear wall 40 and the center wall 41. The sealing screw 38 is screwed firmly into the center wall 41 with a thread 44. The cooling pin 22 is screwed into the front wall 42 through a cooling pin bottom 43 and a thread 44 and has a casing 45 with blast openings 46. There is a ring-shaped air channel 49 between casing 45 and suction pipe 35, which in the threaded area is connected to a pressure chamber 48 through an opening 47 so that compressed air can be blasted into the inside of the preform through the pressure chamber 48, the opening 47, the ring space 29 and the blast openings 46. The pressure chamber 48 is delimited by the center wall 41 and the front wall 42.

The FIGS. 5b, 5c and 5d show three operating conditions. FIG. 5b shows the situation during the intensive cooling, with the suction air being fully active. The blast air can be switched in either fully or in part, as needed. FIG. 5c shows a transfer situation where only the suction air is activated. FIG. 5d shows the ejection phase during the transfer of the preforms to the secondary cooling means with activated blast air.

FIGS. 6a and 6b show a cooling pin 22 developed as blast nozzle. On the left side, the blast nozzle 22 has a screw thread 50, by means of which the blast nozzles 22 can be screwed in at the supporting plate 16. As shown in FIG. 1, the supporting plate 16 has a large number of blast nozzles 22, which are arranged in several rows. Two air systems 52 and 53 are arranged in the supporting plate 16, with the air system 52 being developed for negative pressure and/or vacuum and the air system 53 being developed for compressed air, with appropriate connections (not shown) for a compressed air generator and/or a suction fan or a vacuum pump. To achieve a clear separation between both air systems, special screws 54, 55 and 56 with the required recesses for mounting and penetration of the respective connection pieces are provided at the transitions. It is imperative that the special screws 54, 55 and 56 are screwed in and/or out in the proper order. In completely mounted condition, each of the two air systems, which are sealed from one another, should be able to perform its own function. For the compressed air side, a blast pipe 57 according to length “L” is inserted in the proper assembly order. Said blast pipe leads the blast air through a compressed air feed channel 58 into the cooling mandrel 22 up to the orifice 64. A hexagon washer face 59 is provided at the cooling mandrel 22 to firmly screw in the screw thread 50. The suction air connection 61 runs through a ring channel 62 as well as a plurality of cross-holes 63, which connect the ring channel 62 toward the outside close to the sealing ring 60. As a result, air is blown out through the blast orifice 64 and can be suctioned again through the cross-holes 63. Flexible and pressure-resistant air hoses 31 and 32 provide the connection to the appropriate compressed air—or suction air sources (FIG. 1). The air hoses are developed accordingly for high pressure and vacuum. Advantageously, the entire air system has tube-like connections for the high pressure range as well as for the negative pressure range, which is optimal for the stability issue. The reference symbol 65 refers to the centering base of the cooling mandrels 22. FIG. 6a shows an end piece of the supporting plate 16 with a screwed-in air nozzle 66. The outer diameter DB at the cooling mandrel 22 is slightly smaller than the corresponding inner diameter of the preform 10. This results in a centering effect for the preform 10 on the blast nozzles 22, which is supported by the air flow forces.

FIG. 6d shows the blast nozzle in operating position during the calibration and FIG. 6c shows a preform in sectional view. FIG. 6c shows the two parts of a preform, i.e., the threaded part 70 as well as the blow-moulded part 71. The blow-moulded part 71 has three segments: a neck segment 72, a conical segment 73 and a cylindrical segment 74. The neck segment 72 has an essentially smaller wall strength Ws-2 relative to the cylindrical segment 74, which has a wall strength Ws-1. The wall material of the blow-moulded part is required for the enormous magnification during the basting process and/or in the production of PET bottles. In FIGS. 6a and 6b, the blast nozzle 22 has a clearance groove 75, with a sealing ring 76 being inserted into said clearance groove.

FIG. 6d shows the blast nozzle 22 in calibration position, with a gap 79 remaining between the shoulder 77 and the edge 78 of the open preform side. The sealing ring 76 rests on the interior wall of the preform 10 in the conical area 73 and forms the seal 80. The seal 80 divides the interior part of the preform into two segments: the front pressure chamber 81 and a rear cooling chamber 82.

FIG. 7 shows the situation with the calibration of a preform 10 with simultaneous outside cooling in cooling sleeves according to the embodiment in FIGS. 6a to 6d. In the rear cooling space 82, the + sign indicates that an overpressure is created for the calibration. It is important that the preform, if it is in the cooling sleeve 21, has direct wall contact. This applies in particular also for the entire bottom part of the preform and the inner bottom part of the cooling sleeve.

FIG. 8 shows a solution that is different from the solution according to FIG. 7 in particular in two areas. The blast nozzle 22 has a seal 90, 90′, 90″ which rests on the edge 78 at the face side and forms the seal at this location. To create the actual tight closing, the supporting plate 16 is pressed on the edge 78 with a precise path—and power controlled movement. At the same time, the bottom area 83 is pushed on the convex inner bottom part 91 of the cooling sleeve. The cooling sleeve 21 is developed with thin walls. This applies primarily also to the spherically shaped bottom part 91. The spherically shaped bottom part 91 has a neck 92 that is held and sealed in a base plate 93 relative to the cooling water side. The cooling water 30 is fed into an interior cooling space 95 through a forward run channel 94, flows along the outside wall area of the cooling sleeve 21 and leaves said outer wall area through an opening 96 over an outer cooling space 96 and the backflow channel 98. The air system is developed as a closed system. Compressed air is blown into the interior of the preform 10 through a blast pipe 57 and a blast orifice 64 of the blast nozzle. The air is suctioned off through cross-holes 63 as well as a ring channel 62 by a vacuum source (not shown). Both sides can be precision tuned by precisely controlling the movements as well as the powers, mechanically as well as with respect to the air powers, in particular in the most critical phase at the start of the calibration when the preforms are completely introduced.

FIGS. 9a and 9b show a cooling pin 22 on a larger scale. The blast mandrel is comprised essentially of a blast mandrel base 100 with a cylindrical guide part 101 that is slightly conically tapered toward the front. A tubular extension 102 is firmly connected to the blast mandrel base 100, and a contact head 103 is movably arranged on said extension. The movement of the contact head 22 is limited by a cotter 104 held in the contact head 103 as well as a guide slit 105 cut into the tubular extension. The contact head 103 is delimited by a cooling pin tip 106, which is screwed into the contact head 103. On the opposite side, the blast mandrel base 100 has a thread 50 a well as a multi-edged screw head 59 through which the cooling pins 22 can be screwed into the supporting plate 16. On the face side, a sealing ring 90 is inserted at the screw head to form a tight seal with the open end side of a preform. Air can be blasted in through an opening 110 in the blast mandrel base 100. The blast air travels through a compressed air boring 111 into a blast air chamber 112 and can flow out from there through borings 115 as well as ring-shaped slit openings 103 corresponding to arrows 116 in the ring-shaped space between the contact head 103 and the interior side 117 of the preform 10. What is interesting here is that the spherically shaped part 118 of the blast mandrel tip 106, which is in direct contact with the mandrel-shaped part of the preform, also develops an intensive cooling effect. It is clear here that in addition to the intensive cooling effect of the blast air, an additional direct contact cooling of the sprue area is achieved. These effects should be seen positively because the sprue 119, which is formed last in the injection moulds by the hot injection mass, is cooled rather poorly in the casting moulds and therefore forms the actually hottest location in a preform after it is removed from the casting moulds. As already explained earlier, the actual length of the cooling pin Be-L is obtained based on the distance ratios between the cooling pin on the one side as well as the inner length i.L. of the preform or the position of the preform in the cooling sleeve on the other hand. The required power is provided by the pressure of the blast air in the blast air chamber. However, suction air can be removed as well through the opening 110 in the blast air base 100. The suction air is primarily used for the handling. Furthermore, as a result of the appropriate negative pressure in the chamber 112, the contact head 103 on the one side and the entire preform on the other side is pulled back until it makes contact with the sealing ring 90.

FIG. 10 shows the situation after a preform 10 is transferred from the mould halves to a removal device with simultaneous external cooling in the cooling sleeves of the removal device. It is important here that the preform, if it is in the cooling sleeve 21, has wall contact. This applies in particular also to the entire bottom part 83 of the preform 10.

FIG. 5 shows the solution currently seen as the best form relative to the cooling sleeve 21. The bottom area 83 of the preform is pulled toward the convex inner bottom part 91 of the cooling sleeve bottom 49 by the vacuum in space 42 for intensive cooling. All walls of the cooling sleeve 21 are developed as thin walls. This applies primarily also to the cooling sleeve bottom 49. The cooling sleeve bottom 49 has a neck part 92 that is held and sealed in a base plate 93 relative to the cooling water side. The cooling water 30 is fed into an inner cooling space 95 through a forward run channel 94, flows along the outside wall area of the cooling sleeve 21 and leaves said cooling sleeve through an opening 96′ through an outer cooling space 96 and through the backflow channel 98.

FIG. 11 shows the cooling pin 22 of FIG. 9a inside a preform 10 during the active intensive cooling phase. Blast air is blasted in as compressed air, for example 1 to 4 bar, according to arrow 110 and flows into the inside of the preform 10 according to arrow 66 and freely out of the preform according to arrows 121.

FIG. 12 shows the phase of the intensive cooling of the inner side and outer side of the preforms, with the cooling of the preforms occurring on the outside with contact cooling with the water-cooled cooling sleeves and on the inside with a contact cooling in the mandrel-shaped part of the preforms 10 of the contact head 103 and simultaneously by the blast air 110.

The FIGS. 13a and 13b show another embodiment of a blast nozzle 22. However, here the solution according FIGS. 13a and 13b differs in three areas from that in FIGS. 9a and 9b. FIG. 13a has an additional connection for vacuum and/or suction air. This has the advantage that the two air systems can be activated by simply opening or closing the appropriate valves 26 and/or 27. Vacuum air is suctioned only through the cross-holes 63. The tubular extension 102 has a smaller diameter over a traversing distance Vw and thus a retaining ring 123 held in the contact head 103 delimits the tight and released position of the contact head 103. Similar to the solution according to FIG. 9a, the contact head 103 has blow-out openings 114. Furthermore, the FIGS. 13a and 13b have two-way air blast slits 122 in the spherically shaped area 118′. The front-most tip 124 can be closed to achieve a direct contact cooling at the respective point. The hemispherical bottom part 118′ itself is cooled with blast air according to FIGS. 13a and 13b.

FIG. 14a shows another embodiment with a contact head 103. The contact head 103 is arranged to move axially in a collet 131. Through a collar 132, the contact head acts like a piston in a pneumatic cylinder. The contact head 103 is moved forward with the blast air. After the cooling pin 22 has been introduced completely, the contact head can adjust freely, i.e., move slightly forward or back and remain in continuous contact with the inner bottom part 118 of the preform 10. The actual contact is ensured by a spacer 133. The solution according to FIG. 10 additionally shows a compression spring 134, which holds the contact head 103 continually in the front position regardless of the air pressure. A bottleneck 135 in the contact head 103 limits the air quantity. The blast air flows out freely at the position 136 and flows into the interior of the preform according to arrow 137. FIG. 10 shows that a blast air chamber 112, which adjusts respectively, is formed depending on the position of the contact head 103. Depending on the desired effect, the gliding surfaces 138 and 139 can be sealed or used as an additional blow out opening. The FIGS. 14b and 14c show two additional embodiments, with primarily the spacers 133 as well as the glide guides for the contact head being developed differently. The embodiment according to FIGS. 5a and 5b shows a cooling sleeve 21 of the secondary cooling means, which has on its upper end an extension 141 having a closing element 141 with a guide opening. Said closing element has an arch 147 in its inner area, and the hemispherical bottom of the injection mould dips into said arch. A piston element in the form of a valve pin 144 is supported in the extension 141 to move freely mechanically in axial direction, with a through-channel in the form of grooves being developed in the extension 141. The grooves are through-passages for an air exchange between the air space 42′ and the interior space of the cooling sleeve 21 and ensure a pressure exchange between the space 142 and the inner side of the cooling sleeve 21. The through opening has on its side facing the air space 142 a conical enlargement 145 which can accommodate the valve pin 144 with an appropriately developed cone-shaped valve seat 146 as a seal (FIG. 5a, right). When the cooling sleeves 21 are filled with the injection moulds, which are still semi-rigid at this point, the valve pin 144 is pulled upward by the negative pressure in the air space 142, which causes the negative pressure to propagate from the airspace 142 through the grooves in the through-opening into the interior space of the cooling sleeve 21, where it pulls in the injection mould completely. After the cooling phase is completed, the airspace 142 is switched from negative pressure to overpressure, which presses the valve pin 144 down and in doing so follows the completely cooled injection mould mechanically for a brief part of the path. However, the movement path of the valve pin 144 is limited by the stop of its cone-shaped valve set 146 on the conical enlargement 145 of the through-opening 142, which automatically prevents any escape of compressed air and thus maintains the air pressure in the airspace 142.

FIGS. 16a to 16d show a particularly interesting embodiment with a yielding contact head 103 that is slightly moved forward by a compression spring with little pressure in resting position (FIG. 16b). With the positioning movement of the cooling pin 22, the frontal hemispherical part 118 contacts the interior bottom part 99 of the preform 10. The supporting plate 16 continues the positioning movement of the cooling pin 22, thus creating a slight contact pressure between the contact head 103 and the inner bottom part 99 of the preform. According to FIG. 16c, the compressed air as well as the suction air are activated, and as a result, a slight gap Sp of maximally a few millimeters, preferably only a few tenth of a millimeter up to a half millimeter is created, through which the cooling air is suctioned from the inside of the preform. The slight gap has the special advantage that the cooling air flows through the gap at a maximum rate in particular as streamlined flow and develops the optimum cooling effect in the inner mandrel-shaped part of the preform 10. The cooling effect can be further supported by adapting the spherical part 118 optimally to the inner bottom part 99 of the preform 10. FIG. 16d shows the situation when the preform 10 is ejected from the cooling pin. Only the compressed air is activated here.

FIGS. 17a to 17d show another interesting embodiment of the cooling pin 22, with an expandable casing 150. A cooling medium, which can be air or water, for example, is supplied to the cooling pin 22. FIG. 17b shows the introduction movement of the cooling pin. The interior of the casing 150 is without pressure or there is a slight negative pressure so that the outer form of the casing 150 is smaller than the corresponding inner form of a preform 10. According to FIG. 17c, the compressed air is pressed into the interior of the casing, with cooling air being blown in or suctioned off to support the circulation of air. The casing is pressed completely to the inner side of the preform, thus generating a specific calibration of the still very hot preform. The preform completely assumes the inner form of the outer cooling sleeve, analog to FIGS. 6 to 8. Because a cooling medium circulates inside the casing, the casing simultaneously has a good cooling effect on the inner side of the preforms. FIG. 17d shows the detaching of the preform from the cooling pin, for example with appropriate suction effect of a secondary cooler according to FIG. 5d.

1-21. (canceled)

22. A method of manufacturing a preform, comprising:
injection molding the preform in an open mould half of an injection molding machine;
removing the preform from the open mould half of the injection molding machine in a hot state via a removing device;
physically contacting the preform with a cooling sleeve via the removing device by moving the preform in a substantially linear manner, an inner surface of the cooling sleeve substantially corresponding to an outer surface of the preform;
after the step of removing, cooling an inner portion of the preform via a cooling pin and an outer portion of the preform via the cooling sleeve; and
after the step of cooling, further cooling the preform;
wherein a duration of the further cooling is substantially a multiple of a duration of the injection molding.

23. The method of claim 22, wherein a movement of the cooling pin is substantially synchronized with a timing of the injection molding.

24. The method of claim 22, further comprising controlling a displacement and/or a power of the removing device during the step of bringing the preform into physical contact with the cooling sleeve.

25. The method of claim 22, wherein an inside of the preform is cooled for a duration between about two seconds and about seven seconds.

26. The method of claim 22, wherein an inside of the preform is cooled for a duration between about 3% and about 10% of the duration of the further cooling.

27. The method of claim 22, wherein an inside of the preform is cooled until the outer surface of the preform is dimensionally stable.

28. The method of claim 22, wherein the cooling pin and the preform substantially form a seal.

29. The method of claim 22, further comprising supplying air into and suctioning the air out of the preform during the step of cooling.

30. The method of claim 22, further comprising creating an overpressure in the preform during the step of cooling.

31. The method of claim 22, further comprising calibrating the preform by pressing the outer surface of the preform into the inner surface of the cooling sleeve.

32. The method of claim 22, further comprising circulating a cooling fluid through an inflatable casing disposed around the cooling pin.

33. The method of claim 22, wherein the step of physically contacting includes creating a negative pressure between the inner surface of the cooling sleeve and the outer surface of the preform.

34. The method of claim 22, wherein the step of physically contacting includes creating an overpressure between the removing device and the inner surface of the preform.

35. The method of claim 22, wherein the preform is cooled so as to minimize temperature differences in the preform.

36. The method of claim 22, wherein the preform is cooled so as to minimize crystallization in the preform.

37. The method of claim 22, wherein the cooling pin has a substantially tubular shape and includes a suction opening at a tip of the cooling pin.

38. The method of claim 22, further comprising placing the cooling pin into the preform so as to leave a gap between a tip of the cooling pin and an inner-mandrel-shaped bottom portion of the preform sufficient to allow cooling air to be suctioned from the preform via the cooling pin.

39. The method of claim 22, wherein the cooling pin includes a yielding contact head configured to be pushed away from an inner bottom of the preform when a cooling fluid is circulated through the preform during the step of cooling.

40. The method of claim 22, wherein the cooling sleeve is water-cooled.

41. A device for cooling a preform after the preform has been removed from an open mould half of an injection molding machine, comprising:
a cooling pin configured to be introduced into the preform and cool an inner portion of the preform;
a removal station including a cooling sleeve, the cooling sleeve having an inner surface which substantially corresponds to an outer surface of the preform, the cooling sleeve being configured to cool an outer portion of the preform;
a removal device configured to remove the preform from the open mould half of the injection molding machine and place the preform into the cooling sleeve via a substantially linear movement; and
a controller configured to control the movement of the preform.

42. The device of claim 41, wherein the cooling sleeve is a water-cooled cooling sleeve.

43. The device of claim 41, wherein the cooling pin is disposed on a plate.

44. The device of claim 41, wherein the cooling pin is configured to be connected to a vacuum source, the vacuum source being configured to suction a cooling fluid from an inside of the preform.

45. The device of claim 41, wherein a bottom portion of the preform has an inner mandrel shape, and the cooling pin includes a suction pipe, the cooling pin being configured such that an end of the suction pipe is disposed adjacent the bottom portion of the preform.

46. The device of claim 43, wherein the cooling pin includes a casing having a base, the base including a discharge hole configured to discharge a cooling fluid and a connector configured to be connected to a source of compressed cooling fluid via the plate.

47. The device of claim 43, wherein the plate is configured to move relative to the removal station.

48. The device of claim 43, wherein the plate includes a connector configured to be connected to a source of compressed cooling fluid such that an introduction of the compressed cooling fluid from the source into the preform via the plate generates a swelling pressure in the preform that calibrates the preform in the cooling sleeve.

49. The device of claim 43, wherein the plate includes a blowing mandrel and an elastic seal, the cooling sleeve including the elastic seal,
wherein the elastic seal is configured to form a substantially airtight seal with an inner surface of the preform so as to allow a swelling pressure to be generated inside the preform.

50. The device of claim 41, wherein the preform has a threaded portion, and the cooling pin includes a soft packing configured to form a substantially airtight seal with an outer edge of the threaded portion of the preform so as to allow a pressure to be generated inside the preform.

51. The device of claim 47, wherein the cooling pin is configured to be introduced into the preform via the movement of the plate relative to the removal station.

52. The device of claim 41, wherein the cooling pin is configured to yield relative to the preform in the direction of the substantially linear movement.

53. The device of claim 41, wherein the preform has a bottom portion, the bottom portion having an inner mandrel shape, and the cooling pin includes a blast mandrel configured to be introduced into the preform with a controlled force until the blast mandrel contacts the bottom portion of the preform.

54. The device of claim 41, wherein the cooling pin includes:
a blast mandrel having a tubular extension, the tubular extension including a blast air boring; and
a contact head movable relative to the tubular extension, the contact head including a blast chamber in flow communication with the blast air boring.

55. The device of claim 41, wherein the preform has a bottom portion, the bottom portion having an inner mandrel shape, and the cooling pin includes a contact head configured to contact and cool the bottom portion of the preform.

56. The device of claim 53, further comprising one of a source of blast air and a compression spring,
wherein the one of the source of blast air and the compression spring is configured to generate the controlled force.

57. The device of claim 41, wherein the cooling pin includes a sleeve-like contact head configured to move relative to another portion of the cooling pin via a force generated by one of a source of blast air and a compression spring.

58. The device of claim 41, wherein the removal station is structurally independent from the injection molding machine and configured to be independently controlled relative to the injection molding machine.

59. The device of claim 41, wherein the removal station includes a plurality of cooling sleeves.

60. The device of claim 42, wherein the plate is movable relative to the cooling pin.

61. The device of claim 41, further comprising a secondary cooler configured to cool the preform after the preform has been cooled in the cooling sleeve.

62. The device of claim 41, wherein the controller is configured to cyclically control the flow of a cooling fluid through one or more of the cooling pin and the cooling sleeve.
